(19) United States
(12) Patent Application Publication
(10) Pub. No.: US 2016/0160041 A1
(43) Pub. Date: Jun. 9, 2016

(54) FLAME RETARDANT THERMOPLASTIC AND THERMOSET COMPOSITIONS

(71) Applicant: FRX Polymers, Inc., Chelmsford, MA (US)

(72) Inventors: Xiudong SUN, Weston, MA (US); Zhiyuan LAN, Lowell, MA (US); Kevin R. TRUDEL, Chelmsford, MA (US)

(73) Assignee: FRX Polymers, Inc., Chelmsford, MA (US)

(21) Appl. No.: 14/957,774

(22) Filed: Dec. 3, 2015

Related U.S. Application Data
(60) Provisional application No. 62/087,110, filed on Dec. 3, 2014.

(51) Int. Cl. C08L 67/02

(52) U.S. Cl. CPC C08L 67/02

(57) ABSTRACT

Disclosed are new compositions consisting of mixtures of flame retardants for thermoplastic and thermoset polymers with the addition of halogenated compounds and phosphonate oligomers, polymers or copolymers, and optionally, additional flame retardants. The compositions exhibit excellent flame retardant properties. Further disclosed are articles of manufacture produced from these materials, such as fibers, films, coated substrates, moldings, foams, fiber-reinforced articles, wires, and cables including these compositions, or any combination thereof.

### CROSS-REFERENCE TO RELATED APPLICATIONS

The application claims priority from U.S. Provisional No. 62/087,110 entitled “Flame Retardant Thermoplastic and Thermoset Compositions” filed Dec. 3, 2014, the entirety of which is hereby incorporated by reference.

### GOVERNMENT INTERESTS

Not applicable

### PARTIES TO A JOINT RESEARCH AGREEMENT

Not applicable

### INCORPORATION BY REFERENCE OF MATERIAL SUBMITTED ON A COMPACT DISC

Not applicable

### BACKGROUND

The state-of-the-art approach to rendering polymers flame retardant is to use additives such as halogenated compounds (mainly bromine or chlorine containing), inorganic materials (such as, aluminum trihydrate), and/or nitrogen or phosphorus containing compounds. Some halogenated compounds are toxic, persistent, and bioaccumulate. Moreover, these compounds typically have low molecular weights and can leach into the environment over time, which makes their use less desirable. In some countries, certain halogenated additives are being phased-out of use because of these environmental concerns. To overcome this problem, polymeric brominated flame retardants have been introduced to the market that will not migrate out of the final polymer mixtures anymore and therefore people will not be exposed while using the final applications that contain these compounds.

When brominated or other halogenated compounds are used, typically antimony trioxide (ATO) is used as a synergist. ATO is also a low molecular weight additive that can migrate out of the polymer compositions and has toxicology concerns. Although using high molecular weight halogenated compounds may mitigate leaching of the halogenated compound, high molecular weight halogenated compounds do not stop leaching of ATO. Furthermore, the specific gravity of ATO is relatively high. This means that a relatively high weight amount of ATO needs to be added to polymer formulations where ATO is used as a synergist to halogenated flame retardants. Finally, the availability and price of ATO is very unpredictable. For these reasons, it is desired to find an alternative to ATO that works together with halogenated flame retardants.

### SUMMARY OF THE INVENTION

Various embodiments of the invention are directed to compositions including a base polymer, a halogenated compound, and a phosphonate component having repeating units derived from diaryl alkylphosphonate or diaryl arylphosphonate. In some embodiments, the phosphonate component may have a weight average molecular weight (Mw) of about 10,000 g/mole to about 100,000 g/mole, as determined by ηᵣₑₗ or GPC. In some embodiments, the the phosphonate component may have a number average molecular weight (Mn) of about 5,000 g/mole to about 50,000 g/mole, and in certain embodiments, the phosphonate component may have a molecular weight distribution (Mw/Mn) of about 2 to about 10. In particular embodiments, the phosphonate component may have a relative viscosity of from about 1.10 to about 1.40. In some embodiments, the phosphonate component may have a phosphorous content of about 2% to about 18% by weight.

In certain embodiments, the phosphonate component may be an oligomeric phosphonate or polyphosphonate of Formula I:

I

wherein Ar is an aromatic group and —O—Ar—O— is derived from resorcinol, hydroquinone, methyl hydroquinone, bisphenol A, bisphenol F, 4,4′-biphenol, phenolphthalein and phenolphthalein derivatives, 4,4′-thiodiphenol, 4,4′-sulfonyldiphenol, 1,1-bis-(4-hydroxyphenyl)-3,3,5-trimethylcyclohexane, or combinations thereof, R is a C₁₋₂₀ alkyl, C₂₋₂₀ alkene, C₂₋₂₀ alkyne, C₅₋₂₀ cycloalkyl, or C₆₋₂₀ aryl, and n is an integer from 1 to about 200. In some embodiments, the phosphonate component may be a random or block copoly(phosphonate carbonate) or a random or block co-oligo(phosphonate carbonate) of Formula II:

II

wherein Ar¹ and Ar² are aromatic groups and each —O—Ar¹—O— and —O—Ar²—O— is, individually, derived from resorcinol, hydroquinone, bisphenol A, bisphenol F, 4,4′-biphenol, phenolphthalein, 4,4′-thiodiphenol, 4,4′-sulfonyldiphenol, 1,1-bis-(4-hydroxyphenyl)-3,3,5-trimethylcyclohexane, and combinations thereof, each R is, independently, C1-20 alkyl, C2-20 alkene, C2-20 alkyne, C5-20 cycloalkyl, or C6-20 aryl, and each m and n is, independently, an integer from 1 to about 200. In particular embodiments, the phosphonate component may be a random or block copoly(phosphonate ester) or random or block co-oligo(phosphonate ester) of Formula III:

III

wherein A¹ is an aromatic group and each —O—Ar¹—O— is, individually, derived from resorcinol, hydroquinone, bisphenol A, bisphenol F, 4,4′-biphenol, phenolphthalein, 4,4′-thiodiphenol, 4,4′-sulfonyldiphenol, 1,1-bis-(4-hydroxyphenyl)-3,3,5-trimethylcyclohexane, and combinations thereof, each R is, independently, C₁₋₂₀ alkyl, C₂₋₂₀ alkene, C₂₋₂₀ alkyne, C₅₋₂₀ cycloalkyl, or C₆₋₂₀ aryl, each R¹ and R² are, individually, aliphatic or aromatic hydrocarbons, and each n and p is, independently, an integer from 1 to about 200. In certain embodiments, the phosphonate component may be selected from the group consisting of compounds of Formulae IV, V, and VI:

IV

wherein n is 1 to 200;

V

wherein each n and m is, individually, 1 to 200; and

VI

wherein each n and p is, individually, 1 to 200. In various embodiments, the composition may include about 1% to about 30% by weight phosphonate component.

In some embodiments, the halogenated compound in the compositions described above may be chlorinated paraffins, dedecachloropentacyclooctadecadiene (dechlorane), brominated diphenyl ethers, decabromodiphenyl ether, brominated trimethylphenylindanes, tetrabromophthalic anhydride and diols derived therefrom, tetrabromobisphenol A, hexabromocyclododecane, polypentabromobenzyl acrylates, oligomeric reaction products derived from tetrabromobisphenol A with epoxides, brominated polycarbonate, brominated carbonate oligomers, brominated polystyrene, brominated styrene-butadiene copolymer, tris(1-chloro-2-propyl) phosphate, and combinations thereof. In various embodiments, the composition may include about 1% to about 30% by weight halogenated compound.

In some embodiments, the compositions described above may include a phosphorous containing flame retardant such as, but not limited to, inorganic phosphates, insoluble ammonium phosphate, organophosphates and phosphonates, halophosphates such as chlorophosphates and bromophosphates, halophosphonates, chlorophosphonates, bromophosphonates, phosphine oxides, phosphinate salts, red phosphorus, and combinations thereof. In various embodiments, such compositions may include about 1% to about 30% by weight phosphorous-containing flame retardant.

In some embodiments, the compositions described above may include a metal hydroxide or metal oxide hydroxide such as, but not limited to, aluminum hydroxide, beryllium hydroxide, cobalt hydroxide, copper hydroxide, curium hydroxide, gold hydroxide, iron hydroxide, magnesium hydroxide, mercury hydroxide, nickel hydroxide, tin hydroxide, uranyl hydroxide, zinc hydroxide, zirconium hydroxide, gallium hydroxide, lead hydroxide, thallium hydroxide, alkaline earth metal hydroxides, nickel iron hydroxide, metal oxidehydroxides, and combinations thereof. In various embodiments, such compositions may include about 1% to about 30% by weight metal hydroxide or metal oxide hydroxide.

In some embodiments, the compositions described above may include a nitrogen-containing additive such as, but not limited to, melamine, melamine cyanurate, melamine derivatives, melamine salt, and combinations thereof. In various embodiments, such compositions may include about 1% to about 30% by weight nitrogen-containing additive.

In various embodiments, the base polymer in the compositions described above may be a thermoplastic polymer such as, but not limited to, acrylics, poly(methyl methacrylate) (PMMA) and acrylonitrile butadiene styrene (ABS), polyamides such as nylon, polybenzimidazole (PBI, short for Poly-[2,2′-(m-phenylen)-5,5′-bisbenzimidazole]), polyethylene (PE) including ultra-high molecular weight polyethylene (UHMWPE), high-density polyethylene (HDPE), medium-density polyethylene (MDPE), low-density polyethylene (LDPE) and (LLDPE), and cross-linked polyethylene (XLPE or PEX), polypropylene (PP), polystyrene including extruded polystyrene foam (XPS), expanded polystyrene foam (EPS), polyvinyl chloride (PVC), polytetrafluoroethylene (PTFE), polyesters including polyethylene terephtalate (PET), polybutylene terephtalate (PBT), thermoplastic polyester elastomer (TPEE), thermoplastic polyurethanes (TPU), and polycarbonate (PC). In other embodiments, the base polymer in the compositions described above may be a thermoset resin such as, but not limited to, polyurethane, vulcanized rubber, bakelite, duroplast, urea-formaldehyde foam, melamine resin, diallyl-phthalate (DAP), epoxy resin, polyimide cyanate ester, polycyanurate, and polyester resins.

In some embodiments, the compositions described above may further include one or more additives such as, but not limited to, fillers, lubricants, surfactants, organic binders, polymeric binders, crosslinking agents, coupling agents, anti-dripping agents, fluoropolymers, heat and light stabilizers, antistatic agents, antioxidants, nucleating agents, carbodiimide, colorants, inks, dyes, UV absorbers and light stabilizers, 2-(2,′-hydroxyphenyl)-benzotriazoles, 2-hydroxybenzophenones, esters of optionally substituted benzoic acids, acrylates, nickel compounds, sterically hindered amines, oxalic acid diamides, metal deactivators, phosphites, phosphonites, compounds that destroy peroxide, basic costabilizers, nucleating agents, reinforcing agents, plasticizers, emulsifiers, pigments, optical brighteners, blowing agents, and combinations thereof. In particular embodiments, the compositions described above may further include antimony trioxide. In some embodiments, the compositions described above may further include one or more reinforcing materials such as, but not limited to, carbon fibers, glass fibers, glass beads, minerals, chalk, anti-dripping agents, polytetrafluoro ethylene, and fluoropolymers.

Various embodiments of the invention include methods for making compositions such as those described above including the steps of combining a phosphorous component and a halogenated compound into a mixture and homogenizing the mixture in a melt containing a base polymer. In various embodiments, the mixture may further include a metal hydroxide, metal oxide hydroxide, nitrogen-containing compound, phosphorous-containing compound, additional additive, or combination thereof.

Various additional embodiments include articles of manufacture including a composition containing a base polymer, a phosphorous component and a halogenated compound such as those described above. In some embodiments, the articles may be, for example, fibers, films, sheets, and molded articles.

### DESCRIPTION OF THE DRAWINGS

Not applicable

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

“Optional” or “optionally” means that the subsequently described event or circumstance may or may not occur, and that the description includes instances where the event occurs and instances where it does not.

“Substantially no” means that the subsequently described event may occur at most about less than 10% of the time or the subsequently described component may be at most about less than 10% of the total composition, in some embodiments, and in others, at most about less than 5%, and in still others at most about less than 1%.

The term “aromatic diol” is meant to encompass any aromatic or predominately aromatic compound with at least two associated hydroxyl substitutions. In certain embodiments, the aromatic diol may have two or more phenolic hydroxyl groups. Examples of aromatic diols include, but are not limited to, 4,4′-dihydroxybiphenyl, hydroquinone, resorcinol, methyl hydroquinone, chlorohydroquinone, acetoxyhydroquinone, nitrohydroquinone, 1,4-dihydroxynaphthalene, 1,5-dihydroxynaphthalene, 1,6-dihydroxynaphthalene, 2,6-dihydroxynaphthalene, 2,7-dihydroxynaphthalene, 2,2-bis(4-hydroxyphenyl)propane, 2,2-bis(4-hydroxy-3,5-dimethylphenyl)propane, 2,2-bis(4-hydroxy-3,5-dichlorophenyl)propane, 2,2-bis(4-hydroxy-3-methylphenyl)propane, 2,2-bis(4-hydroxy-3-chlorophenyl)propane, bis(4-hydroxyphenyl)methane, bis(4-hydroxy-3,5-dimethylphenyl)methane, bis(4-hydroxy-3,5-dichlorophenyl)methane, bis(4-hydroxy-3,5-dibromophenyl)methane, bis(4-hydroxy-3-methylphenyl)methane, bis(4-hydroxy-3-chlorophenyl)methane, 1,1-bis(4-hydroxyphenyl)cyclohexane, bis(4-hydroxyphenyl)ketone, bis(4-hydroxy-3,5-dimethylphenyl)ketone, bis(4-hydroxy-3,5-dichlorophenyl)ketone, bis(4-hydroxyphenyl) sulfide bis(4-hydroxyphenyl) sulfone, phenolphthalein and phenolphthalein derivatives, 4,4′-thiodiphenol, 4,4′-sulfonyldiphenol, 4,4,-dihydroxydiphenylether, and 1,1-bis-(4-hydroxyphenyl)-3,3,5-trimethylcyclohexane. In some embodiments, a single aromatic diol may be used, and in other embodiments, various combinations of such aromatic diols may be incorporated into the polymer.

The term “alkyl” or “alkyl group” refers to a branched or unbranched hydrocarbon or group of 1 to 20 carbon atoms, such as but not limited to methyl, ethyl, n-propyl, isopropyl, n-butyl, isobutyl, t-butyl, octyl, decyl, tetradecyl, hexadecyl, eicosyl, tetracosyl and the like. “Cycloalkyl” or “cycloalkyl groups” are branched or unbranched hydrocarbons in which all or some of the carbons are arranged in a ring such as but not limited to cyclopentyl, cyclohexyl, methylcyclohexyl and the like. The term “lower alkyl” includes an alkyl group of 1 to 10 carbon atoms.

The term “aryl” or “aryl group” refers to monovalent aromatic hydrocarbon radicals or groups consisting of one or more fused rings in which at least one ring is aromatic in nature. Aryls may include but are not limited to phenyl, napthyl, biphenyl ring systems and the like. The aryl group may be unsubstituted or substituted with a variety of substituents including but not limited to alkyl, alkenyl, halide, benzylic, alkyl or aromatic ether, nitro, cyano and the like and combinations thereof.

“Substituent” refers to a molecular group that replaces a hydrogen in a compound and may include but are not limited to trifluoromethyl, nitro, cyano, C₁-C₂₀ alkyl, aromatic or aryl, halide (F, Cl, Br, I), C₁-C₂₀ alkyl ether, C₁-C₂₀ alkyl ester, benzyl halide, benzyl ether, aromatic or aryl ether, hydroxy, alkoxy, amino, alkylamino (—NHR′), dialkylamino (—NR′R″) or other groups which do not interfere with the formation of the intended product.

As defined herein, an “arylol” or an “arylol group” is an aryl group with a hydroxyl, OH substituent on the aryl ring. Non-limiting examples of an arylol are phenol, naphthol, and the like. A wide variety of arlyols may be used in the embodiments of the invention and are commercially available.

The term “alkanol” or “alkanol group” refers to a compound including an alkyl of 1 to 20 carbon atoms or more having at least one hydroxyl group substituent. Examples of alkanols include but are not limited to methanol, ethanol, 1- and 2-propanol, 1,1-dimethylethanol, hexanol, octanol and the like. Alkanol groups may be optionally substituted with substituents as described above.

The term “alkenol” or “alkenol group” refers to a compound including an alkene 2 to 20 carbon atoms or more having at least one hydroxyl group substituent. The hydroxyl may be arranged in either isomeric configuration (cis or trans). Alkenols may be further substituted with one or more substituents as described above and may be used in place of alkenols in some embodiments of the invention. Alkenols are known to those skilled in the art and many are readily available commercially.

As used herein, the term “about” means plus or minus 10% of the numerical value of the number with which it is being used. Therefore, about 50% means in the range of 45%-55%.

A “flame retardant” refers to any compound that inhibits, prevents, or reduces the spread of fire.

The terms “flame retardant,” “flame resistant,” “fire resistant,” or “fire resistance,” as used herein, mean that the composition exhibits a limiting oxygen index (LOI) of at least 27. “Flame retardant,” “flame resistant,” “fire resistant,” or “fire resistance” may also refer to the flame reference standard ASTM D6413-99 for textile compositions, flame persistent test NF P 92-504, and similar standards for flame resistant fibers and textiles. Fire resistance may also be tested by measuring the after-burning time in accordance with the UL test (Subject 94). In this test, the tested materials are given classifications of UL-94 V-0, UL-94 V-1 and UL-94 V-2 on the basis of the results obtained with the ten test specimens. Briefly, the criteria for each of these UL-94-V-classifications are as follows:

UL-94 V-0: the maximum burning time after removal of the ignition flame should not exceed 10 seconds and the total burning time (t1+t2) for five tested specimen should not exceed 50 seconds. None of the test specimens should release any drips which ignite absorbent cotton wool.

UL-94 V-1: the maximum burning time after removal of the ignition flame should not exceed 30 seconds and the total burning time (t1+t2) for five tested specimen should not exceed 250 seconds. None of the test specimens should release any drips which ignite absorbent cotton wool.

UL-94 V-2: the maximum burning time after removal of the ignition flame should not exceed 30 seconds and the total burning time (t1+t2) for five tested specimen should not exceed 250 seconds. The test specimens may release flaming particles, which ignite absorbent cotton wool.

Fire resistance may also be tested by measuring after-burning time. These test methods provide a laboratory test procedure for measuring and comparing the surface flammability of materials when exposed to a prescribed level of radiant heat energy to measure the surface flammability of materials when exposed to fire. The test is conducted using small specimens that are representative, to the extent possible, of the material or assembly being evaluated. The rate at which flames travel along surfaces depends upon the physical and thermal properties of the material, product or assembly under test, the specimen mounting method and orientation, the type and level of fire or heat exposure, the availability of air, and properties of the surrounding enclosure. If different test conditions are substituted or the end-use conditions are changed, it may not always be possible by or from this test to predict changes in the fire-test-response characteristics measured. Therefore, the results are valid only for the fire test exposure conditions described in this procedure.

The term “toughness,” as used herein, is meant to imply that the material is resistant to breaking or fracturing when stressed or impacted. There are a variety of standardized tests available to determine the toughness of a material. Generally, toughness is determined qualitatively using a film or a molded specimen.

The term “fiber” means a stable fiber or monofilament or multi-filament continuous or chopped strand of any diameter and shape fabricated by any known method from a polymeric composition.

“Number averaged molecular weight” can be determined by relative viscosity (ηᵣₑₗ) and/or gel permeation chromatography (GPC). Unless otherwise indicated, the values recited are based on polystyrene standards. Relative viscosity (ηᵣₑₗ) is a measurement that is indicative of the molecular weight of a polymer and is generally measured by dissolving a known quantity of polymer in a solvent and comparing the time it takes for this solution and the neat solvent to travel through a capillary (i.e., viscometer) at a constant temperature. It is also well known that a low relative viscosity is indicative of a low molecular weight polymer. Low molecular weight may causes mechanical properties such as strength and toughness to be worse compared to higher molecular weight samples of the same polymers. Therefore, reducing the relative viscosity of a polymer would be expected to result in a reduction in mechanical properties, for example, poor strength or toughness compared to the same composition which has a higher relative viscosity.

GPC is a type of chromatography that separates polymers by size. This technique provides information about the molecular weight and molecular weight distribution of the polymer, i.e., the polydispersity index (PDI).

A “thermoplastic” refers to any polymer that becomes flexible when heated and return to a solid state after being cooled. As such, thermoplastics can be melted and molded repeatedly. Non-limiting examples of thermoplastics include acrylics such as poly(methyl methacrylate) (PMMA) and acrylonitrile butadiene styrene (ABS), polyamides such as nylon, polybenzimidazole (PBI, short for Poly-[2,2′-(m-phenylen)-5.5′-bisbenzimidazole]), polyethylene (PE) including ultra-high molecular weight polyethylene (UHMWPE), high-density polyethylene (HDPE), medium-density polyethylene (MDPE), low-density polyethylene (LDPE) and (LLDPE), and cross-linked polyethylene (XLPE or PEX), Polypropylene (PP), polystyrene including extruded polystyrene foam (XPS), expanded polystyrene foam (EPS), polyvinyl chloride (PVC), polytetrafluoroethylene (PTFE), polyesters including polyethylene terephtalate (PET), polybutylene terephtalate (PBT), thermoplastic polyester elastomer (TPEE), thermoplastic polyurethanes (TPU), polycarbonate (PC) and the like.

A “thermoset” refers to any polymer that irreversibly cures. After curing, thermoset resins cannot be remelted by heating. Non-limiting examples of thermosets include polyurethanes, vulcanized rubber, bakelite, duroplast, urea-formaldehyde foams, melamine resins, diallyl-phthalate (DAP), epoxy resins, polyimides cyanate esters or polycyanurates, (unsaturated) polyester resins, and the like.

A “phosphinate” refers to any inorganic phosphinate salt, organic phosphinate salt, phosphinate esters or salts of phosphinic acids. A phosphinic acid salt may be of the formula (I) or (II)

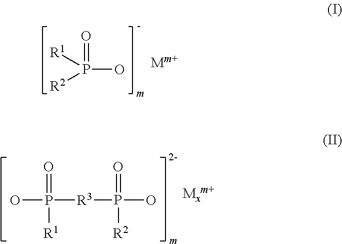

where R¹ and R² are identical or different and are H or C₁-C₆-alkyl, linear or branched, an aryl, or a combination thereof; M is Mg, Ca, Al, Sb, Sn, Ge, Ti, Fe, Zr, Ce, Bi, Sr, Mn, Li, Na, K, Zn, a protonated nitrogen base, or a combination thereof, calcium ions, magnesium ions, aluminum ions, zinc ions, or a combination thereof; m may be from 1 to 4; n may be from 1 to 4; x may be from 1 to 4. In some embodiments, m may be 2 or 3 for formula (I); n may be 1 or 3, and x may be 1 or 2 for formula (II).

Embodiments of the invention are directed to polymer compositions containing a base polymer, such as, a thermoplastic or a thermoset, a halogenated compound, and a phosphonate component that includes an oligomeric phosphonate, polyphosphonate, or copolyphosphonate. Like ATO, the phosphonate component may provide an improved flame retardancy to formulations that contain halogenated compounds, although the mechanism may be different. ATO is typically used as a synergist with halogenated flame retardants in plastics because it forms flame quenching antimony tri-halides through a gas-phase mechanism. The phosphonate variants of this invention would not be expected to have the same mechanism and therefore it is unexpected and surprising that the phosphonate components actually can replace ATO while giving the same FR performance. Additionally, oligomeric and polymeric phosphonate components do not leach out like ATO or have the toxicity concerns that are related to ATO. Compared to other (low molecular weight) phosphor containing compounds like metal phosphonates, phosphinate salts, or phosphates, the phosphonate compounds of the invention have the advantage of an improved hydrolytic stability and improved leachability that make the use of these phosphonate components preferred to known phosphorous containing additives.

Examples of suitable halogenated compounds include, but are not limited to, brominated or chlorinated flame retardants such as chlorinated paraffins, dedecachloropentacyclooctadecadiene (dechlorane), brominated diphenyl ethers such as decabromodiphenyl ether, brominated trimethylphenylindanes, tetrabromophthalic anhydride and diols derived therefrom, tetrabromobisphenol A, hexabromocyclododecane, polypentabromobenzyl acrylates, oligomeric reaction products derived from tetrabromobisphenol A with epoxides, brominated polycarbonate and brominated carbonate oligomers, brominated polystyrene, brominated styrene-butadiene copolymer, and compounds that contain both halogen and phosphorus atoms such as tris(1-chloro-2-propyl) phosphate. In some embodiments, the halogenated compounds may generate halogen species which, in the gas phase, interfere with free radical organic “fuel” from the polymer substrate extinguishing flames.

The amount of the halogenated compound added to the polymer composition may vary within wide limits. For example, polymer compositions may include these compounds from about 1% to about 60% by weight, based on the total composition, about 5% to about 40% by weight, based on the total composition, about 10% to about 25% by weight, about 15% to about 20% by weight, or a value between any of these ranges. The ideal amount depends on the nature of the polymer and on the type of other components, and on the character of the actual halogenated compound used.

Embodiments of the invention are not limited by the type of phosphonate component included and may include, for example, polyphosphonates, branched polyphosphonates, hyberbranched polyphosphonates, and oligomers thereof, random copolyphosphonates, oligophosphonates, co-oligo(phosphonate ester)s, or co-oligo(phosphonate carbonate)s, and in certain embodiments, the phosphonate component may have the structures described and claimed in U.S. Pat. Nos. 6,861,499, 7,816,486, 7,645,850, and 7,838,604 and U.S. Publication No. 2009/0032770, each of which is hereby incorporated by reference in its entirety.

Such phosphonate components may include repeating units derived from diaryl alkylphosphonates or diaryl arylphosphonates. For example, in some embodiments, such phosphonate components include structural units illustrated by Formula I:

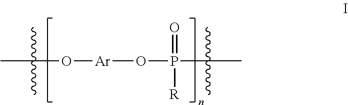

where Ar is an aromatic group and —O—Ar—O— may be derived from a dihydroxy compound having one or more, optionally substituted, aryl rings such as, but not limited to, resorcinols, hydroquinones, and bisphenols, such as bisphenol A, bisphenol F, and 4,4′-biphenol, phenolphthalein or phenolphthalein derivatives, 4,4′-thiodiphenol, 4,4′-sulfonyldiphenol, 1,1-bis-(4-hydroxyphenyl)-3,3,5-trimethylcyclohexane, or combinations of these, R is a C₁₋₂₀ alkyl, C₂₋₂₀ alkene, C₂₋₂₀ alkyne, C₅₋₂₀ cycloalkyl, or C₆₋₂₀ aryl, and n is an integer from 1 to about 200, 1 to about 100, 1 to about 75, 1 to about 50, 1 to about 20, 1 to about 10, or 2 to about 5, or any integer between these ranges.

In certain embodiments, the phosphonate component may be a polyphosphonate containing long claims of the structural unit of Formula I. In some embodiments, the polyphosphonates may have a weight average molecular weight (Mw) of about 10,000 g/mole to about 100,000 g/mole as determined by ηᵣₑₗ or GPC, and in other embodiments, the polyphosphonates may have an Mw of from about 12,000 to about 80,000 g/mole as determined by ηᵣₑₗ or GPC. The number average molecular weight (Mn) in such embodiments may be from about 5,000 g/mole to about 50,000 g/mole, or from about 8,000 g/mole to about 15,000 g/mole, and in certain embodiments the Mn may be greater than about 9,000 g/mole. The molecular weight distribution (i.e., Mw/Mn) of such polyphosphonates may be from about 2 to about 10 in some embodiments and from about 2 to about 5 in other embodiments. In still other embodiments, the polyphosphonates may have a relative viscosity of from about 1.10 to about 1.40.

In some embodiments, the phosphonate component may be a random copoly(phosphonate carbonate). These random copoly(phosphonate carbonate)s may include repeating units derived from at least 20 mole percent high purity diaryl alkylphosphonate or optionally substituted diaryl alkylphosphonate, one or more diaryl carbonate, and one or more aromatic dihydroxide, wherein the mole percent of the high purity diaryl alkylphosphonate is based on the total amount of transesterification components, i.e., total diaryl alkylphosphonate and total diaryl carbonate. As indicated by the term “random” the monomers of the copoly(phosphonate carbonate)s of various embodiments are incorporated into polymer chain randomly. Therefore, the polymer chain may include alternating phosphonate and carbonate monomers linked by an aromatic dihydroxide and/or various segments in which several phosphonate or several carbonate monomers form oligophosphonate or polyphosphonate or oligocarbonate or polycarbonate segments. Additionally, the length of various oligo or polyphosphonate oligo or polycarbonate segments may vary within individual copoly(phosphonate carbonate)s.

The phosphonate and carbonate content of the copoly(phosphonate carbonate)s may vary among embodiments, and embodiments are not limited by the phosphonate and/or carbonate content or range of phosphonate and/or carbonate content. For example, in some embodiments, the copoly(phosphonate carbonate)s may have a phosphorus content, which is indicative of the phosphonate content of from about 1% to about 20% by weight of the total copoly(phosphonate carbonate), and in other embodiments, the phosphorous content of the copoly(phosphonate carbonate)s of the invention may be from about 2% to about 10% by weight of the total polymer.

The copoly(phosphonate carbonate)s of various embodiments exhibit both a high molecular weight and a narrow molecular weight distribution (i.e., low polydispersity). For example, in some embodiments, the copoly(phosphonate carbonate)s may have a weight average molecular weight (Mw) of about 10,000 g/mole to about 100,000 g/mole as determined by ηᵣₑₗ or GPC, and in other embodiments, the copoly(phosphonate carbonate)s may have a Mw of from about 12,000 to about 80,000 g/mole as determined by ηᵣₑₗ or GPC. The number average molecular weight (Mn) in such embodiments may be from about 5,000 g/mole to about 50,000 g/mole, or from about 8,000 g/mole to about 15,000 g/mole, and in certain embodiments the Mn may be greater than about 9,000 g/mole. The narrow molecular weight distribution (i.e., Mw/Mn) of such copoly(phosphonate carbonate)s may be from about 2 to about 7 in some embodiments and from about 2 to about 5 in other embodiments. In still other embodiments, the random copoly(phosphonate carbonate)s may have a relative viscosity of from about 1.10 to about 1.40.

In other embodiments, the copoly(phosphonate carbonate)s, co-oligo(phosphonate carbonate)s, or co-oligo(phosphonate ester)s, may have structures such as, but not limited to, those structures of Formulae II and III, respectively:

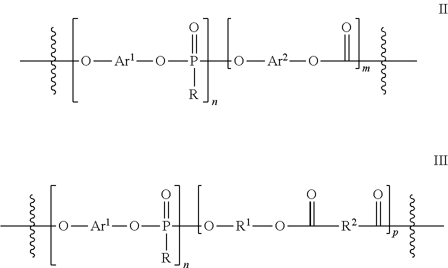

and combinations thereof, where Ar, Ar¹, and Ar² are each, independently, an aromatic group and —O—Ar—O— may be derived from a dihydroxy compound having one or more, optionally substituted aryl rings such as, but not limited to, resorcinols, hydroquinones, and bisphenols, such as bisphenol A, bisphenol F, and 4,4′-biphenol, phenolphthalein, or phenolphthalein derivatives, 4,4′-thiodiphenol, 4,4′-sulfonyldiphenol, 1,1-bis-(4-hydroxyphenyl)-3,3,5-trimethylcyclohexane, or combinations of these, R is a C₁₋₂₀ alkyl, C₂₋₂₀ alkene, C₂₋₂₀ alkyne, C₅₋₂₀ cycloalkyl, or C₆₋₂₀ aryl, R¹ and R² are aliphatic or aromatic hydrocarbons, and each m, n, and p can be the same or different and can, independently, be an integer from 1 to about 200, 1 to about 100, 1 to about 75, 1 to about 50, 1 to about 20, 1 to about 10, or 2 to about 5, or any integer between these ranges. In certain embodiments, each m, n and p are about equal and generally greater than 5 or less than 15.

As indicated by the term “random,” the monomers of the “random co-oligo(phosphonate carbonate)s” or “random co-oligo(phosphonate ester)s” of various embodiments are incorporated into the polymer chain randomly, such that the oligomeric phosphonate chain can include alternating phosphonate and carbonate or ester monomers or short segments in which several phosphonate or carbonate or ester monomers are linked by an aromatic dihydroxide. The length of such segments may vary within individual random co-oligo(phosphonate carbonate)s or co-oligo(phosphonate ester)s.

In particular embodiments, the Ar, A¹, and Ar² may be derived from bisphenol A and R may be a methyl group providing polyphosphonates, oligomeric phosphonates, random and block co-oligo(phosphonate carbonate)s and co-oligo(phosphonate ester)s having reactive end-groups. Such compounds may have structures such as, but not limited to, structures of Formulae IV, V, and VI:

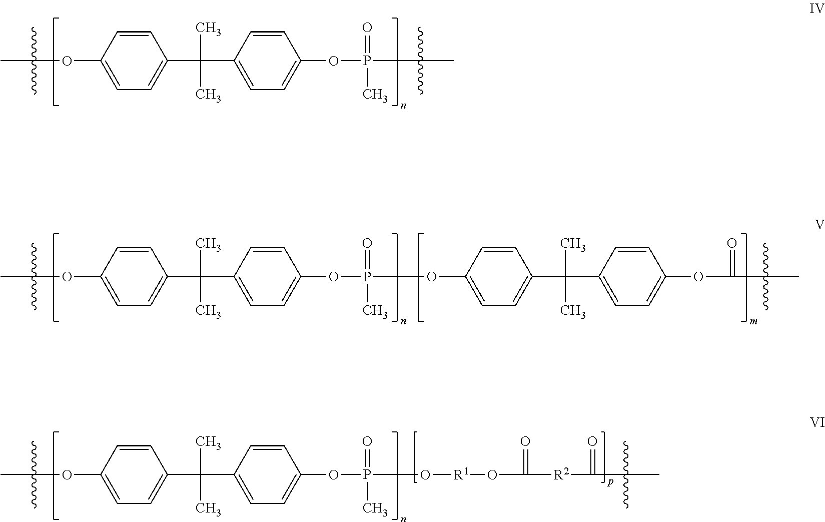

and combinations thereof, where each of m, n, p, and R¹ and R² are defined as described above. Such co-oligo(phosphonate ester), or co-oligo(phosphonate carbonate) may be block co-oligo(phosphonate ester), block co-oligo(phosphonate carbonate) in which each m, n, and p is greater than about 1, and the copolymers contain distinct repeating phosphonate and carbonate blocks or phosphonate and ester blocks. In other embodiments, the oligomeric co-oligo(phosphonate ester) or co-oligo(phosphonate carbonate) can be random copolymers in which each m, n, and p can vary and may be from n is an integer from 1 to about 200, 1 to about 100, 1 to about 75, 1 to about 50, 1 to about 20, 1 to about 30, from 1 to about 20, 1 to about 10, or 2 to about 5, where the total of m, n, and p is an integer from 1 to about 200, 1 to about 100, 1 to about 75, 1 to about 50, 1 to about 20, 1 to about 10, or 2 to about 5 or any integer between these ranges.

In some embodiments, bisphenol A may be the only (i.e., 100%) bisphenol used in the preparation of the phosphonate component and in other embodiments, bisphenol A may make up about 5% to about 90%, about 10% to about 80%, about 20% to about 70%, about 30% to about 60%, about 40% to about 50%, or a value between any of these ranges, with the remainder another bisphenol such as any one or more of the bisphenols described above.

The phosphorous content of phosphonate component may be controlled by the molecular weight (MW) of the dihydroxy compound used in the oligomeric phosphonates, polyphosphonates, or copolyphosphonates. A lower molecular weight dihydroxy compound may produce an oligomeric phosphonate, polyphosphonate, or copolyphosphonate with a higher phosphorus content. Dihydroxy compound, such as resorcinol, hydroquinone, or a combination thereof or similar low molecular weight dihydroxy compounds may be used to make oligomeric phosphonates or polyphosphonates with high phosphorous content. The phosphorus content, expressed in terms of the weight percentage, of the phosphonate oligomers, phosphonates, or copolyphosphonates may be in the range from about 2 wt. % to about 18 wt. %, about 4 wt. % to about 16 wt. %, about 6 wt. % to about 14 wt. %, about 8 wt. % to about 12 wt. %, or a value between any of these ranges. In some embodiments, phosphonate oligomers, polyphosphonates, or copolyphosphonates prepared from bisphenol A or hydroquinone may have phosphorus contents of 10.8 wt. % and 18 wt. %, respectively. The phosphonate copolymers have a smaller amount of phosphorus content compared to the phosphonate oligomers and the polyphosphonates.

With particular regard to co-oligo(phosphonate ester)s, co-oligo(phosphonate carbonate)s, block co-oligo(phosphonate ester)s, and block co-oligo(phosphonate carbonate)s, without wishing to be bound by theory, oligomers containing carbonate components, whether as carbonate blocks or randomly arranged carbonate monomers, may provide improved toughness over oligomers derived solely from phosphonates. Such co-oligomers may also provide higher glass transition temperature, T_{g}, and better heat stability over phosphonate oligomers.

The co-oligo(phosphonate carbonate)s of certain embodiments may be synthesized from at least 20 mole % diaryl alkylphosphonate or optionally substituted diaryl alkylphosphonate, one or more diaryl carbonate, and one or more aromatic dihydroxide, wherein the mole percent of the high purity diaryl alkylphosphonate is based on the total amount of transesterification components, i.e., total diaryl alkylphosphonate and total diaryl carbonate. Likewise, co-oligo(phosphonate ester)s of certain embodiments may be synthesized from at least 20 mole % diaryl alkylphosphonate or optionally substituted diaryl alkylphosphonate, one or more diaryl ester, and one or more aromatic dihydroxide, wherein the mole percent of the diaryl alkylphosphonate is based on the total amount of transesterification components.

The phosphonate and carbonate content of the oligomeric phosphonates, random or block co-oligo(phosphonate carbonate)s and co-oligo(phosphonate ester)s may vary among embodiments, and embodiments are not limited by the phosphonate and/or carbonate content or range of phosphonate and/or carbonate content. For example, in some embodiments, the co-oligo(phosphonate carbonate)s or co-oligo(phosphonate ester)s may have a phosphorus content, of from about 1% to about 12% by weight of the total oligomer, and in other embodiments, the phosphorous content may be from about 2% to about 10% by weight of the total oligomer.

In some embodiments, the molecular weight (weight average molecular weight as determined by gel permeation chromatography based on polystyrene calibration) range of the oligophosphonates, random or block co-oligo(phosphonate ester)s and co-oligo(phosphonate carbonate)s may be from about 500 g/mole to about 18,000 g/mole or any value within this range. In other embodiments, the molecular weight range may be from about 1500 g/mole to about 15,000 g/mole, about 3000 g/mole to about 10,000 g/mole, or any value within these ranges. In still other embodiments, the molecular weight range may be from about 700 g/mole to about 9000 g/mole, about 1000 g/mole to about 8000 g/mole, about 3000 g/mole to about 4000 g/mole, or any value within these ranges.

Hyperbranched oligomers of various embodiments have a highly branched structure and a high degree of functionality (i.e., chemical reactivity). The branched structure of such hyperbranched oligomers creates a high concentration of terminal groups, one at the end of nearly every branch that can include a reactive functional group such as hydroxyl end groups, epoxy end groups, vinyl end groups, vinyl ester end groups, isopropenyl end groups, isocyanate end groups, and the like. In some embodiments, the hyperbranched oligomers may have a unique combination of chemical and physical properties when compared to linear oligomeric phosphonates. For example, the high degree of branching can prevent crystallization and can render chain entanglement unlikely, so the hyperbranched oligomers can exhibit solubility in organic solvents and low solution viscosity and low melt viscosity especially when sheared.

In some embodiments, the hyperbranched oligomers can contain branches that are not perfectly (i.e., absolutely regular) arranged. For example, various branches on a single hyperbranched oligomer may have different lengths, functional group composition, and the like and combinations thereof. Consequently, in some embodiments, the hyperbranched oligomers of the invention can have a broad molecular weight distribution. In other embodiments, the hyperbranched oligomers of the invention may be perfectly branched, including branches that are nearly identical, and have a monodisperse molecular weight distribution.

The degree of branching for the hyperbranched oligomers of the invention can be defined as the number average fraction of branching groups per molecule, i.e., the ratio of terminal groups plus branch monomer units to the total number of terminal groups, branch monomer units, and linear monomer units. For linear oligomers, the degree of branching as defined by the number average fraction of branching groups per molecule is zero, and for ideal dendrimers, the degree of branching is one. Hyperbranched oligomers can have a degree of branching which is intermediate between that of linear oligomers and ideal dendrimers. For example, a degree of branching for hyperbranched oligomers may be from about 0.05 to about 1, about 0.25 to about 0.75, or about 0.3 to about 0.6, and in certain embodiments, the hyperbranched oligomers may have a number average fraction of branching groups about 0.5.

The hyperbranched oligomers of the invention may be generically represented by the following structure Formula VII:

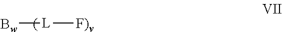

where B is the hyperbranched oligomer and w is the number of branches, v is an integer that is not zero, L is a linking group, and F is a reactive group.

The linking group (L) can be any moiety compatible with the chemistry of the monomers for the oligophosphonate, co-oligo(phosphonate ester), or co-oligo(phosphonate carbonate) described above. For example, in some embodiments, L can be any unit derived from an aryl or heteroaryl group including single aryl groups, biaryl groups, triaryl groups, tetraaryl groups, and so on. In other embodiments, L can be a covalent bond linking a functional group (F) directly to the hyperbranched oligomer, and in still other embodiments, L can be a C₁-C₁₀ alkyl, C₂-C₁₀ alkene, or C₂-C₁₀ alkyne that may or may not be branched.

The linking group (L) allows for attachment of one or more functional groups (F) to each branch termination of the hyperbranched oligomer. In some embodiments, each branch termination may have an attached linking group, and in other embodiments, one or more branch terminations of the hyperbranched oligomer (B) may not have an attached linking group. Such branch terminations without an attached linking group may terminate in a hydroxyl group or phenol group associated with the monomeric units of the hyperbranched oligomer. For branch terminations that include a linking group (L), each linking group may have from 0 to 5 or more associated functional groups. Thus, in some embodiments, one or more linking group of the reactive hyperbranched oligomer may have no attached functional groups, such that the branch termination associated with this linking group is substantially unreactive. In other embodiments, one or more linking group of the reactive hyperbranched oligomer may have one or more attached functional groups providing a branch termination that is potentially reactive with other monomers, oligomers, or polymers, and in still other embodiments, one or more linking groups of the reactive hyperbranched oligomer can have multiple attached functional groups. For example, two of the aryl groups associated with a triaryl group may include a functional group (F) with the third aryl group attaching the linking group to the hyperbranched polymer or oligomer. The functional group (F) may vary among embodiments and can be any chemical moiety capable of reacting with another chemical moiety. Non-limiting examples of functional groups (F) include hydroxyl, carboxylic acid, amine, cyanate, isocyanate, epoxy, glycidyl ether, vinyl, and the like and combinations thereof. The reactive hyperbranched oligomers of the present invention are reactive with a variety of functional groups such as epoxies, anhydrides, activated halides, carboxylic acids, carboxylic esters, isocyanates, aldehydes, vinyls, acetylenes, and silanes. These groups may be present on another monomer, oligomer, or polymer used in the preparation of a polymer composition.

The hyberbranched oligomer portion (B) of the general structure presented above may be any phosphonate containing hyperbranched oligomer. For example, in some embodiments, such hyperbranched oligomers may include repeating units derived from diaryl alkyl- or diaryl arylphosphonates, and certain embodiments, such hyperbranched oligomers may have a structure including units of Formula I:

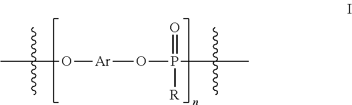

where Ar is an aromatic group and —O—Ar—O— may be derived from a compound having one or more, optionally substituted, aryl rings such as, but not limited to, resorcinols, hydroquinones, and bisphenols, such as bisphenol A, bisphenol F, and 4,4′-biphenol, phenolphthalein, or phenolphthalein derivatives, 4,4′-thiodiphenol, 4,4′-sulfonyldiphenol, 1,1-bis-(4-hydroxyphenyl)-3,3,5-trimethylcyclohexane, or combinations of these, R is a C₁₋₂₀ alkyl, C₂₋₂₀ alkene, C₂₋₂₀ alkyne, C₅₋₂₀ cycloalkyl, or C₆₋₂₀ aryl, and n is an integer from 1 to about 20, 1 to about 10, or 2 to about 5, or any integer between these ranges.

The hyperbranched oligomers (B) of such embodiments may further include units derived from branching agents or multifunctional aryl multifunctional biaryl groups, multifunctional triaryl groups, multifunctional tetra aryl, and so on. In some embodiments, the units derived from branching agents may be derived from, for example, polyfunctional acids, polyfunctional glycols, or acid/glycol hybrids. In other embodiments, the hyperbranched oligomeric phosphonates may have units derived from tri or tetrahydroxy aromatic compounds or triaryl or tetraaryl phosphoric acid esters, triaryl or tetraaryl carbonate or triaryl or tetraaryl esters or combinations thereof such as, but not limited to, trimesic acid, pyromellitic acid, trimellitic anhydride, pyromellitic anhydride, trimethylolpropane, dimethyl hydroxyl terephthalate, pentaerythritol, and the like and combinations thereof. Such branching agents provide branch points within the hyperbranched oligomeric phosphonate. In particular embodiments, the branching agent may be a triaryl phosphate such as, for example, those of Formula VIII:

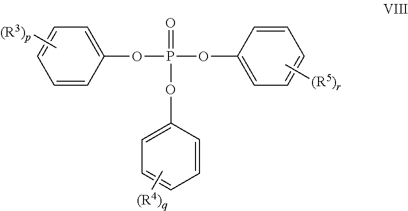

where each R³, R⁴, and R⁵ can, independently, be a hydrogen, C₁-C₄ alkyl of, and each of p, q, and r are independently integers of from 1 to 5.

The number of branches (w) may be directly proportional to the number of units derived from a branching agent and may be any integer from about 2 to about 20. In some embodiments, n may be an integer greater than 3, greater than 5, or greater than 10 or any value within these ranges, and in other embodiments, n may be from about 5 to about 20, about 5 to about 15, about 5 to about 10, or any value between these ranges.

The reactive hyperbranched phosphonates of certain embodiments may have a structure in which B is of Formula IX or Formula X:

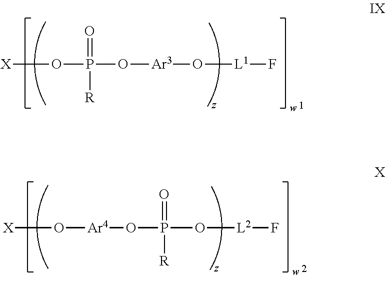

where each Ar³ and Ar⁴ are, independently, an aromatic group and —O—Ar³—O— and —O—Ar⁴—O— can be derived from a dihydroxy compound having one or more, optionally substituted, aryl rings such as, but not limited to, resorcinols, hydroquinones, and bisphenols, such as bisphenol A, bisphenol F, and 4,4′-biphenol, phenolphthalein, or phenolphthalein derivatives, 4,4′-thiodiphenol, 4,4′-sulfonyldiphenol, 1,1-bis-(4-hydroxyphenyl)-3,3,5-trimethylcyclohexane, or combinations of these, each L¹ and L² are, independently, a covalent bond or an aryl or heteroaryl group including single aryl groups, biaryl groups, triaryl groups, tetraaryl groups, and so on, R can be a C₁₋₂₀ alkyl, C₂₋₂₀ alkene, C₂₋₂₀ alkyne, C₅₋₂₀ cycloalkyl, or C₆₋₂₀ aryl, z is an integer from 1 to about 30, 1 to about 20, 1 to about 10, or 2 to about 5, or any integer between these ranges, and each w¹ and w² are, independently, 1 to 5. X may be derived from any branching agent described above. In some embodiments, X in an individual B may be the same molecule, such that branches having a structure of Formula VII and Formula VII may extend from the same branching agent (X) molecule. In particular embodiments, X may be a triarylphosphate of Formula VIII as described above. In other embodiments, two or more X may be linked as illustrated in Formula XI, Formula XII, or Formula XIIII:

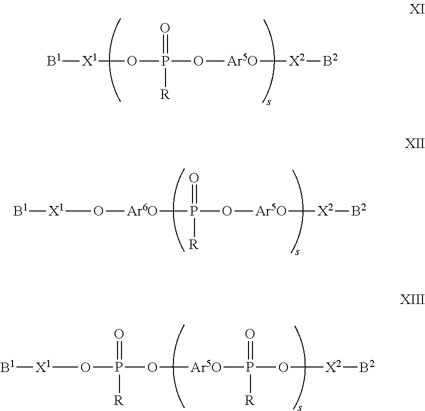

where each B¹ and B² are, independently, hyperbranched polymers as described above, each X¹ and X² are, independently, branching agents as described above, each Ar⁵ and Ar⁶ are, independently, an aromatic group and —O—Ar⁵—O— and —O—Ar⁶—O— can be derived from a dihydroxy compound having one or more, optionally substituted, aryl rings such as, but not limited to, resorcinols, hydroquinones, and bisphenols, such as bisphenol A, bisphenol F, and 4,4′-biphenol, phenolphthalein, or phenolphthalein derivatives, 4,4′-thiodiphenol 4,4′-sulfonyldiphenol, 1,1-bis-(4-hydroxyphenyl)-3,3,5-trimethylcyclohexane or combinations of these, each R is as defined as above, and s is an integer of from 1 to about 30, 1 to about 20, 1 to about 10, or 2 to about 5, or any integer therebetween. In various embodiments, an individual reactive hyperbranched oligomer may have a structure in which portions of the oligomer can be any of Formula I, and VIII to XIII. Thus, embodiments encompass reactive hyperbranched oligomers in having any combination of the Formulae provided above. In other embodiments, a reactive hyperbranched oligomer may be composed of substantially one or two structures of the Formulae presented above. For example, a hyperbranched oligomer may be composed of two units derived from branching agents (X) linked by a structure of Formula XI with branches of Formula IX, or a hyperbranched oligomer may be composed of three or four branching agents linked by structures of Formulae XI and XIII with branches of structure Formula IX. Of course as discussed above, any combination of Formulae are possible and could be present in a single reactive hyperbranched oligomer.

An exemplary representation of a reactive hyperbranched oligomer of the invention is provided below:

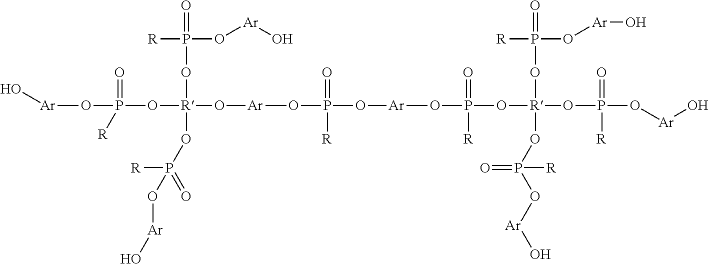

where Ar is an aryl or heteroaryl group, is a C₁-C₄ alkyl group or an aryl group, and R′ is an alkyl or aromatic group derived from a branching agent.

In some embodiments, the molecular weight (weight average molecular weight as determined by gel permeation chromatography based on polystyrene calibration) range of the hyperbranched oligophosphonates, random or block co-oligo(phosphonate ester)s, and co-oligo(phosphonate carbonate)s may be from about 500 g/mole to about 18,000 g/mole or any value within this range. In other embodiments, the molecular weight range may be from about 1500 g/mole to about 15,000 g/mole, about 3000 g/mole to about 10,000 g/mole, or any value within these ranges. In still other embodiments, the molecular weight range may be from about 700 g/mole to about 9000 g/mole, about 1000 g/mole to about 8000 g/mole, about 3000 g/mole to about 4000 g/mole, or any value within these ranges.

The phosphonate and carbonate content of the hyperbranched oligomeric phosphonates, random or block co-oligo(phosphonate carbonate)s, and co-oligo(phosphonate ester)s may vary among embodiments, and embodiments are not limited by the phosphonate and/or carbonate content or range of phosphonate and/or carbonate content. For example, in some embodiments, the co-oligo(phosphonate carbonate)s or co-oligo(phosphonate ester)s may have a phosphorus content, of from about 2% to about 12% by weight, 2% to about 10% by weight, or less than 10% by weight of the total oligomer.

The reactive hyperbranched oligomers of various embodiments may have greater than about 40% or greater than about 50% reactive end groups based on the total number of branch terminations as determined by known titration methods. In certain embodiments, the reactive hyperbranched oligomers may have greater than about 75% or greater than 90% of the reactive end groups based on the total number of branch terminations as determined by titration methods. In further embodiments, the reactive hyperbranched oligomers may have from about 40% to about 98% reactive end groups, about 50% to about 95% reactive end groups, or from about 60% to about 90% end groups based on the total number of branch terminations. As discussed above individual branch terminations may have more than one reactive end group. Therefore, in some embodiments, the reactive hyperbranched oligomers may have greater than 100% reactive end groups. As discussed above, the term “reactive end groups” is used to describe any chemical moiety at a branch termination that is capable of reacting with another chemical moiety. A large number of reactive functional groups are known in the art and encompassed by the invention. In particular embodiments, the reactive end groups may be hydroxyl, epoxy, vinyl, or isocyanate groups.

The oligomeric phosphonates of various embodiments including linear and hyperbranched oligophosphonates can exhibit a high molecular weight and/or a narrow molecular weight distribution (i.e., low polydispersity). For example, in some embodiments, the oligomeric phosphonates may have a weight average molecular weight (Mw) of about 1,000 g/mole to about 18,000 g/mole as determined by ηᵣₑₗ or GPC, and in other embodiments, the oligomeric phosphonates may have a Mw of from about 1,000 to about 15,000 g/mole as determined by ηᵣₑₗ or GPC. The number average molecular weight (Mn), in such embodiments, may be from about 1,000 g/mole to about 10,000 g/mole, or from about 1,000 g/mole to about 5,000 g/mole, and in certain embodiments the Mn may be greater than about 1,200 g/mole. The narrow molecular weight distribution (i.e., Mw/Mn) of such oligomeric phosphonates may be from about 1 to about 7 in some embodiments and from about 1 to about 5 in other embodiments. In still other embodiments, the co-oligo(phosphonate carbonate)s may have a relative viscosity (ηᵣₑₗ) of from about 1.01 to about 1.20. Without wishing to be bound by theory, the relatively high molecular weight and narrow molecular weight distribution of the oligomeric phosphonates may impart a superior combination of properties. For example, the oligomeric phosphonates of embodiments are extremely flame retardant and exhibit superior hydrolytic stability and can impart such characteristics on a polymer combined with the oligomeric phosphonates to produce polymer compositions such as those described below. In addition, the oligomeric phosphonates of embodiments, generally, exhibit an excellent combination of processing characteristics including, for example, good thermal and mechanical properties.

The amount of the phosphonate oligomer, polyphosphonate or copolyphosphonate added to the polymer composition may vary within wide limits. For example, the compositions of embodiments may include from about 1% to about 30% by weight, about 1% to about 20% by weight, about 1% to about 15% by weight, about 1% to about 10% by weight, or about 1% to about 5% by weight based on the total polymer composition or any individual value or range encompassed by these ranges. The amount depends on the nature of the polymer, the type of phosphonate component, and the type of halogenated compound used.

In some embodiments, the polymer compositions may include phosphorous containing flame retardants used in addition to or in place of the phosphonate components described above. Various phosphorous containing flame retardants known in the art such as, for example, inorganic phosphates, insoluble ammonium phosphate, organophosphates and phosphonates, halophosphates such as chlorophosphates and bromophosphates, halophosphonates such as chlorophosphonates and bromophosphonates, phosphine oxides, phosphinate salts, and red phosphorus can be incorporated into the polymer compositions of the invention. When used in place of the phosphonate component, the phosphorous containing flame retardants may be about 1% to about 30% by weight, about 1% to about 20% by weight, about 1% to about 15% by weight, about 1% to about 10% by weight, or about 1% to about 5% by weight based on the total polymer composition or any individual value or range encompassed by these ranges. In embodiments where the phosphorous containing component is used in addition to the phosphonate components described above, the phosphorous containing component may be about 0.1% to about 30% by weight, about 0.1% to about 15% by weight, about 0.1% to about 10% by weight, about 0.1% to about 5% by weight based on the total polymer composition or any individual value or range encompassed by these example ranges.

In certain embodiments, the polymer compositions may include from about 1% to about 60% by weight halogenated compound and from about 1% to about 30% by weight of phosphonate oligomer, polyphosphonate, or copolyphosphonate, and the total amount of halogenated compound and phosphonate component may be about 20% to about 98% by weight of the polymer composition. In other embodiments, the polymer composition may include from about 5% to about 25% by weight halogenated compound, from about 1% to about 20% by weight phosphonate component, and the total amount halogenated compound and phosphonate component may be about 40% to about 94% by weight of the polymer. In other embodiments, the polymer composition may include from about 10% to about 25% by weight halogenated compound, from about 1% to about 10% by weight phosphonate component, and from about 55% to about 89% by weight base polymer, such as thermoplastic or thermoset. Each of the example compositions above may include additional auxiliaries and additives in addition to the base polymer, halogenated compound, and phosphonate component, and the entirety of the components add up to give a total composition of 100% by weight.

In some embodiments, the polymer compositions described above may further include metal hydroxides or metal oxide hydroxides. Metal hydroxides or metal oxide hydroxides may include aluminum hydroxide, beryllium hydroxide, cobalt hydroxide, copper hydroxide, curium hydroxide, gold hydroxide, iron hydroxide, magnesium hydroxide, mercury hydroxide, nickel hydroxide, tin hydroxide, uranyl hydroxide, zinc hydroxide, zirconium hydroxide, gallium hydroxide, lead hydroxide, thallium hydroxide, alkaline earth metal hydroxides, nickel iron hydroxide, metal oxidehydroxides, or a combination thereof. The amount of metal hydroxide or metal oxide hydroxide included in the compositions of the invention may vary and may be from about 0.1% to about 60% by weight, about 0.1% to about 30% by weight, about 0.1% to about 10% by weight, about 0.1% to about 5% by weight based on the total polymer composition or any individual value or range encompassed by these example ranges. The amount depends on the nature of the polymer and on the type of halogenated compound used, on the type phosphonate oligomer, polyphosphonate or copolyphosphonate used, and on the type of metal hydroxide or metal oxide hydroxide used.

In some embodiments, the compositions may include nitrogen-containing additives such as melamine, melamine derivatives, melamine salt or combinations thereof such as, for example, melamine cyanurate. The amount of nitrogen containing additive may be from about 0.1% to about 30% by weight, about 0.1% to about 15% by weight, about 0.1% to about 10% by weight, about 0.1% to about 5% by weight based on the total polymer composition or any individual value or range encompassed by these example ranges.

The polymer compositions described above may include additional additives, such as fillers, lubricants, surfactants, organic binders, polymeric binders, crosslinking agents or chain extenders, coupling agents, anti-dripping agents such as fluoropolymers, heat and light stabilizers, antistatic agents, antioxidants, nucleating agents, carbodiimide, colorants, inks, dyes, or a combination thereof. Additional additives may further include UV absorbers and light stabilizers, 2-(2,′-hydroxyphenyl)-benzotriazoles, 2-hydroxybenzophenones, esters of optionally substituted benzoic acids, acrylates, nickel compounds, sterically hindered amines, oxalic acid diamides, metal deactivators, phosphites, phosphonites, compounds which destroy peroxide, basic costabilizers, nucleating agents, reinforcing agents, plasticizers, emulsifiers, pigments, optical brighteners, antistatics, blowing agents, or a combination thereof. In some embodiments, the polymer compositions may include one or more reinforcing materials such as, for example, carbon fibers, glass fibers, glass beads, or minerals, such as chalk, and anti-dripping agent such as polytetrafluoro ethylene or similar fluoropolymers (e.g. ®Teflon products) in quantities known to produce a desired effect.

The polymer composition may be a participate mixture, a molten mixture, or may be a molded product obtained by solidifying the molten mixture. The solidified molten mixture may be in the form of a molded part, a sheet, or film. The participate mixture may be prepared by mixing the polymer resin with the halogenated compound, and the phosphonate component. The participate mixtures, molten mixtures, and molded products may further include metal hydroxide or metal oxide hydroxide, nitrogen containing compounds, and phosphorous containing compounds as well as additional additives.

Some embodiments are directed to flame retardant mixtures including at least one halogenated compound and at least one phosphonate component or phosphorous containing additive. In certain embodiments, such flame retardant mixtures may further include metal hydroxide or metal oxide hydroxide, nitrogen containing compounds, and phosphorous containing compounds as well as additional additives. The flame retardant mixtures may be used for providing flame retardant properties to a variety of base polymers including thermoplastics and thermoset polymer resins.

Further embodiments are directed to methods for making the compositions described above. There are many possible ways to mix the components, and the order of addition of each component may be in any sequence compatible with the desired mixing process.

In some embodiments, a method for incorporating the halogenated compound and the phosphonate component, and optionally, metal hydroxide or metal oxide hydroxide, nitrogen containing compounds, phosphorous containing compounds and/or additional additives into a polymer may include premixing all of the constituents in the first step in the form of powder and/or pellets in a mixer, and then in a second step, the material may be homogenized in the polymer melt in a compounding assembly. Additional materials such as fillers may also be added and mixed in the first step. The melt may be drawn off in the form of an extrudate, cooled, and pelletized. In other embodiments, a method for incorporating the halogenated compound, and the phosphonate component, and optionally, metal hydroxide or metal oxide hydroxide, nitrogen containing compounds, phosphorous containing compounds and/or additional additives into a polymer may include introducing the halogenated compound, and the phosphonate component by way of a metering system directly into a compounding assembly in any desired order of sequence. In some embodiments, the phosphonate component, and if included, additional fillers, or components, may be added near the end of the extrusion process.

Further methods for incorporating the halogenated compound and the phosphonate component, and optionally, metal hydroxide or metal oxide hydroxide, nitrogen containing compounds, phosphorous containing compounds and/or additional additives may include making pellets different in formulation, mixing the pellets in a certain ratio, and molding a product having a certain formulation from the resulting pellets, a process comprising directly feeding components in a molding machine. Mixing and melt-kneading of a particulate of the polymer resin and other components during the preparation of the flame retardant composition to be used for the molded product may be advantageous to increase dispersion of other components.

The polymer compositions may be melt-kneaded to mold a product with the use of a conventional manner such as an extrusion molding, an injection molding, or compression molding

The polymer compositions can be incorporated into various articles of manufactures including fibers, films, sheets, molded articles, and the like. For example, in some embodiments, the polymer composition may be incorporated into components or sub-assemblies in electric or electronic devices or parts, in mechanical devices or parts, in automotive devices or parts, as packaging material, and as a housing for electrical, mechanical and automotive assemblies or parts. In other embodiments, the flame retardant compositions may be used for covering an electric wire or cable, for example, a conducting wire such as a copper wire or a platinum wire, covering a power transmission wire or a wave-transmission wire such as an optical fiber cable, and the like. In other embodiments, the resin composition may have suitable adhesion to an electric wire. The process for covering wire or cable is not limited and may include a conventional covering process such as, for example, an extrusion molding or press processing. In some embodiments, the wire or cable may be produced by press processing an electric wire while holding the wire between the sheet- or film-like resin compositions. The thermoplastic and thermoset compositions described herein may also be useful in the fabrication a wide variety of electronic components that are used to fabricate consumer electronics that may include computers, printers, modems, laptops computers, cell phones, video games, DVD players, stereos, and similar items.

### EXAMPLES

Although the present invention has been described in considerable detail with reference to certain preferred embodiments thereof, other versions are possible. Therefore, the spirit and scope of the appended claims should not be limited to the description and the preferred versions contained within this specification. Various aspects of the present invention will be illustrated with reference to the following non-limiting examples. The following examples are for illustrative purposes only and are not to be construed as limiting the invention in any manner.

### Materials:

PET—Polyethylene terephthalate with IV of 0.65
PET—Polyethylene terephthalate with IV of 0.89
PBT—Polybutadiene terephthalate, Ultradur B4520 from BASF
HP-1030—brominated polystyrene from Albemarle
BT-93W—ethylenebistetrabromophthalimide from Albemarle
ATO from Great Lakes
Nofia® HM1100 and OL5000 (about 10-11 wt % P—polyphosphonate and phosphonate oligomer from FRX Polymers®
Polytetrafluoroethylene (PTFE)—fine powder 6C from DuPont
Irganox B900 and Irganox 1010 from BASF
Glass Fiber—HP3730 from PPG Industries
Exolit OP 1240—aluminium phosphinate (P content of 23.3-24 wt %) from Clariant

### Methods:

A 27 millimeter twin screw extruder (TSE) was used to compound a variety of compositions of thermoplastic formulations. All of the PET compositions contained 0.3% of polytetrafluoroethylene. When compounding PET, the temperature profile for the extruder started at 220° C. at the feeding block and gradually increased to 255-275° C. at the last zone, depending on the viscosity and grade of PET The compounding was conducted at 25 lbs/hour with a screw speed of around 100 rpm. PET and HM1100 were pre-dried and mixed before putting into the feed hopper.

After adequate drying, the PET molding compositions were processed in an injection molding machine with temperature from 250° C. to 275° C. to produce each test specimen.

For GF PBT, the temperature setting in both compounding and injection molding has a profile of 220-255 C.

UL94: All samples were tested for FR performance according the UL94 test protocol. If a sample did not qualify for a V0, V1, or V2 rating, a qualification of NR (No Rating) was assigned.

### Comparative Examples 1 and 2

Brominated polystyrene and antimony trioxide (ATO) were incorporated into a polyethylene terephthalate (PET) resin as flame retardant additives. Comparative Example 1 included 2 wt. % ATO and 15 wt. % brominated polystyrene and did not provide V0 performance at 0.4 mm (TABLE 1). Comparative Example 2 include 5 wt. % ATO and 15 wt. % brominated polystyrene to provide an ATO/brominated flame retardant ratio of ⅓, which is typical in commercial formulations. This mixture exhibits V0 flame retardancy at 0.4 mm.

### Example 1

Example 1 included 15 wt. % brominated polystyrene, 1 wt. % ATO and 1 wt. % Nofia HM1100, a polyphosphonate. Thus, half of ATO used in Comparative Example 1 was replaced with a phosphonate polymer. Flame retardancy was improved for Example 1 over Comparative Example 1 in that Example 1 exhibited a substantially lower number of flaming drips than in Comparative Example 1, and there was no dripping at all during the first burn in Example 1. Thus, polyphosphonate can replace at least part of ATO while providing better flame retardancy in PET containing brominated polystyrene as the main FR component.

### Example 2

Example 2 included 15 wt. % brominated polystyrene, 6 wt. % Nofia HM1100 (polyphosphonate). Surprisingly, this polymer composition exhibited a V0 UL 94 rating at 0.4 mm. In addition, flame out times were reduced when Nofia HM1100 was used in place of ATO. Thus, the FR performance of the composition in which a polyphosphonate was used was even more robust than the FR performance of a composition that contained ATO that is widely accepted and used as the prime synergist to halogenated flame retardants. The data in Table 1 demonstrated that phosphonates can partially or totally replace ATO in PET compositions where a brominated compound is used as the primary FR additive while delivering similar or improved flame retardancy.

### Comparative Examples 3-6 and Example 3

Another set of experiments was preformed to further study PET of different molecular weight as indicated by IVs. Comparative Examples 3 and 4 only contained brominated polystyrene, i.e. without any synergist. Only a V2 rating at 0.4 mm could be obtained. As expected, adding 5 wt % of ATO to the formulation that contained 15 wt % of brominated PS (Comparative Example 5) gave a boost in FR reducing the flame out times and preventing the occurrence of flaming drips. Consequently, a V0 rating at 0.4 mm was assigned to this formulation. When the same amount of a phosphorus based flame retardant additive such as Exolit OP1240, a phosphinate salt, is used instead of ATO (Comparative Example 6), only a V2 rating at 0.4 mm could be obtained because the composition showed flaming drips. From the state of the art on flame retardancy it is also not expected that a phosphorous based flame retardant could replace ATO as synergist to halogenated FRs. However, when the ATO from Comparative Example 5 is replaced by a same amount of a polyphosphonate (Example 3), also a V0 rating at 0.4 mm was obtained. Compared to Comparative Example 5, where ATO is used, Example 3 was even more robust because it showed fewer drips. Note that the phosphor content in the Nofia HM1100 that was used in Example 6 is much lower than the phosphor content of the Exolit OP1240. Thus, the amount of phosphor as such does not determine the improved effect but rather the chemical nature of the phosphonate component. These data again demonstrate the unexpected behavior and uniqueness of polyphosphonate in replacing ATO polymer resins containing halogenated flame retardants to reach desired flame retardancy.

### Comparative Examples 7-10 and Examples 4-7

Table 3 shows the effect of polyphosphonate in glass filled PBT compositions containing brominated flame retardant additives. Comparative Examples 7 and 8 show that, as expected, using either a halogenated FR or a phosphonate alone is not sufficient to obtain a V0 rating at 0.8 mm. Actually, the samples do not even self-extinguish. Comparative Examples 9 and 10 show the synergistic effect of an amount of 5 wt % ATO in combination with 15 wt % of the brominated additive BT-93W in obtaining a V0 rating at 0.8 mm. An amount of 2.5 wt % of ATO was not sufficient. Surprisingly, with the addition of 2.5 wt % polyphosphonate (Example 4), a V0 rating at 0.8 mm could again be reached. Example 5 and 6 show that without ATO at a relatively low loading of 15 wt % of the halogenated FR, only a V2 rating could be reached when the polyphosphonate was used up to 7 wt %. However, Example 7 shows that when the loading of BT-93W was increased from 15% to 20%, a polyphosphonate and BT-93W combination alone (without ATO) again resulted in a V0 rating at 0.8 mm. The data in Table 3 demonstrated that polyphosphonates can (partially) replace ATO and deliver similar flame retardancy in GF PBT compositions when a halogenated compound is used as the primary FR additive. Each polymer system will probably require its own optimization of the amount and ratio of the halogenated FR and the phosphonate.

TABLE 1
Effect of polyphosphonate in PET (IV 0.64)
compositions containing brominated polystyrene

| | C. Ex. 1 | C. Ex. 2 | EX 1 | EX 2 |
|---|---|---|---|---|
| PET, IV 0.64 [wt %] | 82.7 | 79.7 | 82.7 | 78.7 |
| Brominated PS (HP 1030) [wt %] | 15 | 15 | 15 | 15 |
| Antimony Trioxide [wt %] | 2 | 5 | 1 | |
| Nofia HM1100 [wt %] | | | 1 | 6 |
| UL 94 at 0.4 mm | V2 | V0 | V2 | V0 |
| t1 max, sec | 3 | 1 | 1 | 1 |
| t2 max, sec | 1 | 5 | 1 | 1 |
| t1 + t2 total, sec | 14 | 16 | <10 | <10 |
| total drips/igniting drips, 1st | 3/1 | 0/0 | 0/0 | 0/0 |
| total drips/igniting drips, 2nd | 15/10 | 4/0 | 6/3 | 8/0 |
| Total drips/igniting drips | 18/11 | 4/0 | 6/3 | 8/0 |
| UL 94 at 1.6 mm | | V0 | V0 | V0 |
| t max, sec | | 7 | 1 | 1 |
| t1 + t2 total, sec | | 16 | 10 | 10 |
| Total drips/igniting drips | | 0/0 | 0/0 | 1/0 |

All compositions above are with 0.3% PTFE.

TABLE 2
Effect of polyphosphonate in PET (IV 0.89)
compositions containing brominated polystyrene

| | C. EX. | C. EX. | C. EX. | C. EX. | |
|---|---|---|---|---|---|
| | 3 | 4 | 5 | 6 | EX 3 |
| PET, IV 0.89 [wt %] | 84.7 | 79.7 | 79.7 | 79.7 | 79.7 |
| Brominated PS | 15 | 20 | 15 | 15 | 15 |
| (HP 1030) [wt %] | | | | | |
| Antimony Trioxide [wt %] | | | 5 | | |
| Nofia HM1100 [wt %] | | | | | 5 |
| Exolit 1240 [wt %] | | | | 5 | |
| UL 94 at 0.4 mm | V2 | V2 | V0 | V2 | V0 |
| t1 max, sec | 3 | 1 | 1 | 1 | 1 |
| t2 max, sec | 2 | 1 | 1 | 1 | 1 |
| t1 + t2 total, sec | 18 | 10 | <10 | 10 | <10 |
| total drips/igniting drips, | 5/5 | 1/0 | 0/0 | 5/5 | 0/0 |
| 1st | | | | | |
| total drips/igniting drips, | 13/13 | 8/5 | 17/0 | 10/10 | 7/0 |
| 2nd | | | | | |
| Total drips/igniting drips | 18/18 | 9/5 | 17/0 | 15/15 | 7/0 |

All compositions above are with 0 3% PTFE.

TABLE 3
Effect of polyphosphonate in GF PBT compositions containing
ethylenebistetrabromophthalimide (BT-93W)

| | C. EX. 7 | C. EX. 8 | C. EX. 9 | C. EX. 10 | EX 4 | EX 5 | EX 6 | EX 7 |
|---|---|---|---|---|---|---|---|---|
| PBT [wt %] | 54.1 | 56.6 | 54.1 | 56.6 | 54.1 | 54.1 | 52.1 | 49.1 |
| Glass Fiber [wt %] | 25 | 25 | 25 | 25 | 25 | 25 | 25 | 25 |
| BT-93W [wt %] | 20 | | 15 | 15 | 15 | 15 | 15 | 20 |
| ATO [wt %] | | | 5 | 2.5 | 2.5 | | | |
| Nofia HM1100 [wt %] | | 20 | | | 2.5 | 5 | 7 | 5 |
| Modulus, MPa | | | 7800 | 8200 | 7700 | 7600 | 7700 | 8000 |
| EB at break, % | | | 2.06 | 1.89 | 2.02 | 1.86 | 1.57 | 1.34 |
| TS, MPa | | | 100 | 101 | 100 | 97 | 90 | 85 |
| UL 94 at 0.8 mm | NR | NR | V0 | V2 | V0 | V2 | V2 | V0 |
| t max, sec | >40 | >40 | 1 | 6 | 3 | 28 | 15 | 5 |
| t1 + t2 total, sec | NA | NA | 10 | 26 | 17 | NA | 100 | 20 |
| Total drips/igniting drips | NA | NA | 0/0 | 2/2 | 0/0 | NA | 2/2 | 0/0 |
| Self-Extinguish | No | No | Yes | Yes | Yes | Yes | Yes | Yes |

All compositions above are with 0.31 wt % Irganox B900, Irganox 1010, and Teflon

1. A composition comprising a base polymer, a halogenated compound, and a phosphonate component having repeating units derived from diaryl alkylphosphonate or diaryl arylphosphonate.

2. The composition of claim 1, wherein the phosphonate component has a weight average molecular weight (Mw) of about 10,000 g/mole to about 100,000 g/mole, as determined by ηᵣₑₗ or GPC.

3. The composition of claim 1, wherein the phosphonate component has a number average molecular weight (Mn) of about 5,000 g/mole to about 50,000 g/mole.

4. The composition of claim 1, wherein the phosphonate component has a molecular weight distribution (Mw/Mn) of about 2 to about 10.

5. The composition of claim 1, wherein the phosphonate component has a relative viscosity of from about 1.10 to about 1.40.

6. The composition of claim 1, wherein the phosphonate component has a phosphorous content of about 2% to about 18% by weight.

7. The composition of claim 1, wherein the phosphonate component is an oligomeric phosphonate or polyphosphonate of Formula I: 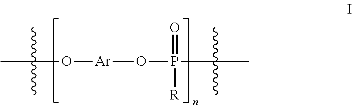
wherein:
Ar is an aromatic group and —O—Ar—O— is derived from resorcinol, hydroquinone, methyl hydroquinone, bisphenol A, bisphenol F, 4,4′-biphenol, phenolphthalein and phenolphthalein derivatives, 4,4′-thiodiphenol, 4,4′-sulfonyldiphenol, 1,1-bis-(4-hydroxyphenyl)-3,3,5-trimethylcyclohexane, or combinations thereof;
R is a C₁₋₂₀ alkyl, C₂₋₂₀ alkene, C₂₋₂₀ alkyne, C₅₋₂₀ cycloalkyl, or C₆₋₂₀ aryl; and
n is an integer from 1 to about 200.

8. The composition of claim 1, wherein the phosphonate component is a random or block copoly(phosphonate carbonate) or a random or block co-oligo(phosphonate carbonate) of Formula II: 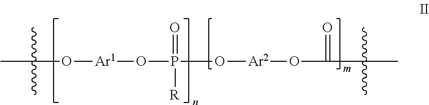
wherein:
Ar¹ and Ar² are aromatic groups and each —O—Ar¹—O— and —O—Ar²—O— is, individually, derived from resorcinol, hydroquinone, bisphenol A, bisphenol F, 4,4′-biphenol, phenolphthalein, 4,4′-thiodiphenol, 4,4′-sulfonyldiphenol, 1,1-bis-(4-hydroxyphenyl)-3,3,5-trimethylcyclohexane, and combinations thereof;
each R is, independently, C₁₋₂₀ alkyl, C₂₋₂₀ alkene, C₂₋₂₀ alkyne, C₅₋₂₀ cycloalkyl, or C₆₋₂₀ aryl; and
each m and n is, independently, an integer from 1 to about 200.

9. The composition of claim 1, wherein the phosphonate component is a random or block copoly(phosphonate ester) or random or block co-oligo(phosphonate ester) of Formula III: 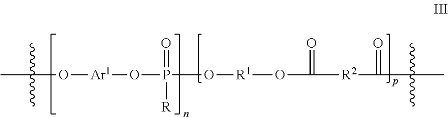
wherein:
A¹ is an aromatic group and each —O—Ar¹—O— is, individually, derived from resorcinol, hydroquinone, bisphenol A, bisphenol F, 4,4′-biphenol, phenolphthalein, 4,4′-thiodiphenol, 4,4′-sulfonyldiphenol, 1,1-bis-(4-hydroxyphenyl)-3,3,5-trimethylcyclohexane, and combinations thereof;
each R is, independently, C₁₋₂₀ alkyl, C₂₋₂₀ alkene, C₂₋₂₀ alkyne, C₅₋₂₀ cycloalkyl, or C₆₋₂₀ aryl;
each R¹ and R² are, individually, aliphatic or aromatic hydrocarbons; and
each n and p is, independently, an integer from 1 to about 200.

10. The composition of claim 1, wherein the phosphonate component is selected from the group consisting of compounds of Formulae IV, V, and VI: 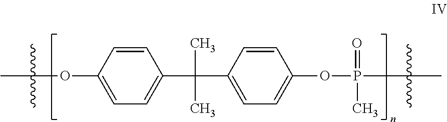
wherein n is 1 to 200; 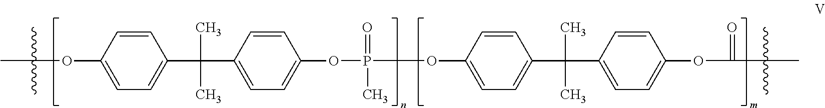
wherein each n and m is, individually, 1 to 200; and 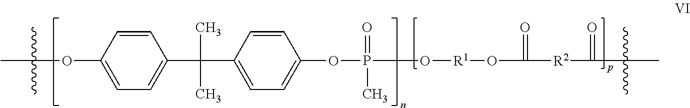
wherein each n and p is, individually, 1 to 200.

11. The composition of claim 1, wherein the composition comprises about 1% to about 30% by weight phosphonate component.

12. The composition of claim 1, wherein the halogenated compound is selected from the group consisting of chlorinated paraffins, dedecachloropentacyclooctadecadiene (dechlorane), brominated diphenyl ethers such as decabromodiphenyl ether, brominated trimethylphenylindanes, tetrabromophthalic anhydride and diols derived therefrom, tetrabromobisphenol A, hexabromocyclododecane, polypentabromobenzyl acrylates, oligomeric reaction products derived from tetrabromobisphenol A with epoxides, brominated polycarbonate, brominated carbonate oligomers, brominated polystyrene, brominated styrene-butadiene copolymer, tris(1-chloro-2-propyl) phosphate, and combinations thereof.

13. The composition of claim 1, wherein the composition comprises about 1% to about 30% by weight halogenated compound.

14. The composition of claim 1, further comprising a phosphorous containing flame retardant selected from the group consisting of inorganic phosphates, insoluble ammonium phosphate, organophosphates and phosphonates, halophosphates such as chlorophosphates and bromophosphates, halophosphonates, chlorophosphonates, bromophosphonates, phosphine oxides, phosphinate salts, red phosphorus, and combinations thereof.

15. The composition of claim 14, wherein the composition comprises about 1% to about 30% by weight phosphorous-containing flame retardant.

16. The composition of claim 1, further comprising a metal hydroxide or metal oxide hydroxide selected from the group consisting of aluminum hydroxide, beryllium hydroxide, cobalt hydroxide, copper hydroxide, curium hydroxide, gold hydroxide, iron hydroxide, magnesium hydroxide, mercury hydroxide, nickel hydroxide, tin hydroxide, uranyl hydroxide, zinc hydroxide, zirconium hydroxide, gallium hydroxide, lead hydroxide, thallium hydroxide, alkaline earth metal hydroxides, nickel iron hydroxide, metal oxidehydroxides, and combinations thereof.

17. The composition of claim 16, wherein the composition comprises about 1% to about 30% by weight metal hydroxide or metal oxide hydroxide.

18. The composition of claim 1, further comprising a nitrogen-containing additive selected from the group consisting of melamine, melamine cyanurate, melamine derivatives, melamine salt, and combinations thereof.

19. The composition of claim 1, wherein the composition comprises about 1% to about 30% by weight nitrogen-containing additive.

20. The composition of claim 1, further comprising antimony trioxide.

21. The composition of claim 1, wherein the base polymer is a thermoplastic polymer selected from the group consisting of acrylics, poly(methyl methacrylate) (PMMA) and acrylonitrile butadiene styrene (ABS), polyamides such as nylon, polybenzimidazole (PBI, short for Poly-[2,2′-(m-phenylen)-5,5′-bisbenzimidazole]), polyethylene (PE) including ultra-high molecular weight polyethylene (UHMWPE), high-density polyethylene (HDPE), medium-density polyethylene (MDPE), low-density polyethylene (LDPE) and (LLDPE), and cross-linked polyethylene (XLPE or PEX), polypropylene (PP), polystyrene including extruded polystyrene foam (XPS), expanded polystyrene foam (EPS), polyvinyl chloride (PVC), polytetrafluoroethylene (PTFE), polyesters including polyethylene terephtalate (PET), polybutylene terephtalate (PBT), thermoplastic polyester elastomer (TPEE), thermoplastic polyurethanes (TPU), and polycarbonate (PC).

22. The composition of claim 1, wherein the base polymer is a thermoset resin selected from the group consisting of polyurethane, vulcanized rubber, bakelite, duroplast, urea-formaldehyde foam, melamine resin, diallyl-phthalate (DAP), epoxy resin, polyimide cyanate ester, polycyanurate, and polyester resins.

23. The composition of claim 1, further comprising one or more additives selected from the group consisting of fillers, lubricants, surfactants, organic binders, polymeric binders, crosslinking agents, coupling agents, anti-dripping agents, fluoropolymers, heat and light stabilizers, antistatic agents, antioxidants, nucleating agents, carbodiimide, colorants, inks, dyes, UV absorbers and light stabilizers, 2-(2,′-hydroxyphenyl)-benzotriazoles, 2-hydroxybenzophenones, esters of optionally substituted benzoic acids, acrylates, nickel compounds, sterically hindered amines, oxalic acid diamides, metal deactivators, phosphites, phosphonites, compounds that destroy peroxide, basic costabilizers, nucleating agents, reinforcing agents, plasticizers, emulsifiers, pigments, optical brighteners, blowing agents, and combinations thereof.

24. The composition of claim 1, further comprising one or more reinforcing materials selected from the group consisting of carbon fibers, glass fibers, glass beads, minerals, chalk, anti-dripping agents, polytetrafluoro ethylene, and fluoropolymers.

25. A method for making a polymer composition comprising:
combining a phosphorous component and a halogenated compound into a mixture; and
homogenizing the mixture in a melt containing a base polymer.

26. The method of claim 25, wherein the mixture further comprises a metal hydroxide, metal oxide hydroxide, nitrogen-containing compound, phosphorous-containing compound, additional additive, or combination thereof.

27. An article of manufacture comprising a polymer composition containing a base polymer, a phosphorous component and a halogenated compound.

28. The article of manufacture of claim 27, wherein the article is selected from the group consisting of fibers, films, sheets, and molded articles.
